(19) United States
(12) Patent Application Publication
(10) Pub. No.: US 2015/0241281 A1
(43) Pub. Date: Aug. 27, 2015

(54) BOLOMETER DEVICE FOR SENSING ELECTROMAGNETIC RADIATION

(71) Applicant: International Business Machines Corporation, Armonk, NY (US)

(72) Inventors: Dan Corcos, Nesher (IL); Danny Elad, Moshav Liman (IL); Noam Kaminski, Kiryat Tivon (IL); Bernhard Klein, Zurich (CH); Lukas Kull, Zurich (CH); Thomas E. Morf, Zurich (CH)

(73) Assignee: International Business Machines Corporation, Armonk, NY (US)

(21) Appl. No.: 14/191,490

(22) Filed: Feb. 27, 2014

(51) Int. Cl. G01J 5/04; G01K 7/00; G01J 5/10

(52) U.S. Cl. CPC G01J 5/04; G01J 5/10; G01K 7/00

(57) ABSTRACT

A bolometer device for use in a bolometer array. The bolometer device of the present invention measures radiation-induced temperature and includes a bolometer sensor and at least one holding element. The bolometer sensor includes at least two antenna elements. The antenna elements are coupled together with one of their ends at a center position. The bolometer sensor also includes a temperature sensing element attached at the center position of the at least two antenna elements, and detects a temperature at the center position. The temperature sensing element also provides an electrical measure in response to the temperature it detects. The holding elements provide support for the bolometer sensor at an end portion of one of the antenna elements. At least one of the holding elements is made of electrically conductive material so an electrical measure can be read out through the holding element.

### BACKGROUND OF THE INVENTION

1. Field of the Invention

The present invention relates to sensing devices. More particularly, bolometer devices for measuring a radiation-induced temperature change.

2. Description of Related Art

The detection of electromagnetic radiation in a range of 0.5 to 1.5 THz has well-established benefits, in particular, in the field of low-cost passive imaging. Passive imaging relies on black body radiation of objects. An object at 300K emits very little signal in the THz range. Nevertheless, passive remote sensing is possible. With THz imaging, high-resolution imaging of hidden objects covered beneath clothing or other materials is feasible. The wide range of applications covers concealed weapon detection, surveillance cameras, astronomy, non-destructive material testing, as well as many biological and medical applications.

Typically, bolometers are used for detecting radiation in the frequency range mentioned above, since electronic devices are not capable of handling such high-frequency radiation. Furthermore, bolometers can be implemented easily in a modified CMOS, or even simpler, in an SOI-CMOS process with MEMS post-processing. For imaging purposes, a plurality of bolometers can be used in arrays, where readout circuitry is also implemented using the same CMOS process.

Classic antenna-coupled bolometer devices include an antenna for receiving electromagnetic radiation and a temperature sensing device. Some temperature-sensing devices include a temperature-dependent resistor, or any kind of electronic device, such as an FET (field effect transistor), which has a strongly temperature-dependent current which can be sensed.

One challenge in designing a bolometer is to support the temperature sensing device such that it is thermally insulated, i.e., with a very high thermal resistance to neighboring structures. Common values for thermal resistances between the temperature sensing device and surrounding structures required for passive THz imaging bolometer applications are within a range of 10⁸ K/W.

PCT Application Publication No. WO 2011/151756 A2 describes a method and a sensing device having a thermal antenna that includes a resistive material and is configured to receive electromagnetic radiation for conversion into heat. The sensing device includes a supporting element. A thermal sensor is arranged to generate detection signals in response to a temperature of a sensing area. The thermal antenna and the thermal sensor are supported by a holding element. The sensor element is electrically connected by conductive traces arranged at the holding element.

U.S. Patent Application Publication No. 2011/0315880 A1 describes a device having at least one thermally insulated metal oxide semiconductor transistor used as a temperature sensor, an absorption structure for the absorption of electromagnetic radiation, electrical and thermal conductors connecting the transistor. The absorption structure absorbs electromagnetic radiation and heats the transistor that transduces temperature changes into an electrical signal.

U.S. Patent Application Publication No. 2003/0222217 A1 describes a microbolometer structure, where a suspended antenna is supported by a substrate. A thermally sensitive element is connected to the antenna and arranged to dissipate electric currents into the antenna. Both the antenna and the thermally sensitive element contain material that is susceptible to achieving a superconductive state below a certain critical temperature. The thermally sensitive element is supported at a distance from the substrate, leaving a gap between the thermally sensitive element and the surface of the substrate or other surrounding structures.

### SUMMARY OF THE INVENTION

The present invention is a bolometer device for use in a bolometer array. The bolometer device includes a bolometer sensor composed of at least two antenna elements, coupled together, with one of their ends at a center position; and a temperature sensing element attached at the center position for detecting a temperature at that center position and for providing an electrical measure in response to the detected temperature. The bolometer device also includes at least one holding elements, where each holding element mechanically supports the bolometer sensor at an end portion of a respective antenna element, and at least one of the holding elements is electrically conductive so that the electrical measure can be read out through the holding element.

### BRIEF DESCRIPTION OF THE DRAWINGS

FIG. 1 shows a bolometer device, for use in a bolometer array, having a spiral antenna.

FIG. 2 shows a bolometer device with termination elements at outer ends of the antenna elements.

FIG. 3 shows a schematic of the circuit of the temperature sensing element.

FIG. 4 shows a schematic of a bolometer device.

FIG. 5 shows a schematic of a bolometer device, which is configured to receive two wavelengths.

FIG. 6 shows a schematic of a bolometer device with a cloverleaf antenna.

FIG. 7 shows a schematic of a circuit of the temperature sensing element for use with the cloverleaf antenna shown in FIG. 6.

### DETAILED DESCRIPTION OF THE PREFERRED EMBODIMENTS

One aspect of the present invention provides a bolometer device, briefly described above, that uses at least one holding element for holding the temperature sensing element and an antenna element connected thereto. The temperature sensing element and the antenna element are held by connecting an outer portion of the antenna element to a support element by the holding element. The holding element can be configured to provide a thermal insulation, an electrical connection to the temperature sensing element for readout and a mechanical support for both the antenna element and the temperature sensing element to keep them in place. Hence, an improved design for a bolometer device can be provided which facilitates readout of the sensing signals, has improved support of the temperature sensing element and the antenna element, and has improved thermal insulation with respect to the temperature sensing element.

Moreover, the bolometer sensor can be supported by at least one of the holding elements, so that it is kept distanced, or separated, from surrounding structures. The holding element may have a length which provides a thermal resistivity of typically 10⁸ K/W.

According to one embodiment of the present invention, the antenna elements can be formed as to spirally extend in an outward direction from the center position. Alternatively, the antenna elements can be formed as to linearly extend in an outward direction from the center position.

As a further alternative, the antenna elements can be formed as a cloverleaf antenna, where the antenna elements are formed as antenna windings which extend outwardly from the center position.

The holding elements can be integrally formed of an electrically conductive first material, in particular of polysilicon or active silicon. The antenna elements can include a layer of a second material that has a better conductivity than the first material that forms the holding elements. The antenna elements can also be made entirely of the second material so that they have a substantial higher electrical conductivity than the holding elements. Metal can be used as the second material.

The present invention also envisions that the termination elements with a higher impedance than the antenna elements and the holding elements can be arranged between the holding elements and their respective antenna elements, at positions to define effective lengths of the antenna elements.

The temperature sensing element can have a circuit that includes a termination resistor for each of the antenna elements via which the antenna elements are coupled to a common node, a capacitor for blocking a DC voltage or current caused by reading out the electrical measure, and a temperature sensor, in particular, a field effect transistor, coupled to the common node.

In particular, the temperature sensing element can have blocking resistors for coupling the temperature sensor to respective antenna elements so that the current induced by the reception of electromagnetic radiation is substantially blocked from the temperature sensor.

The bolometer sensor can have four antenna elements extending crosswise from the center position.

A plurality of bolometer sensors can be provided, where at least one antenna element of each of the bolometer sensors overlaps another antenna element of another one of the bolometer sensors. This creates overlap of absorbing areas of the bolometer sensors.

Furthermore, the antenna elements of the bolometer sensors can have different effective lengths to provide sensitivities in different frequency ranges.

The present invention also envisions that at least one holding element for each of the plurality of bolometer sensors can be prestressed so that they are each bent in a different direction, but perpendicular to its extension plane, as to increase the distance between crossing areas of the antennas elements.

Furthermore, at least one of the holding elements can be used to mechanically support only the bolometer sensor.

Moreover, a support frame may be provided in which the bolometer sensor is centrally arranged. Here, each of the holding elements couples the bolometer sensor to one side of the support frame.

Another aspect of the present invention provides a bolometer system that includes at least one of the bolometer devices described above and a readout unit arranged outside at least one of the support frames of at least one of the bolometer devices. The readout unit is electrically coupled with at least one of the temperature sensing devices by at least one of the holding elements of each bolometer device.

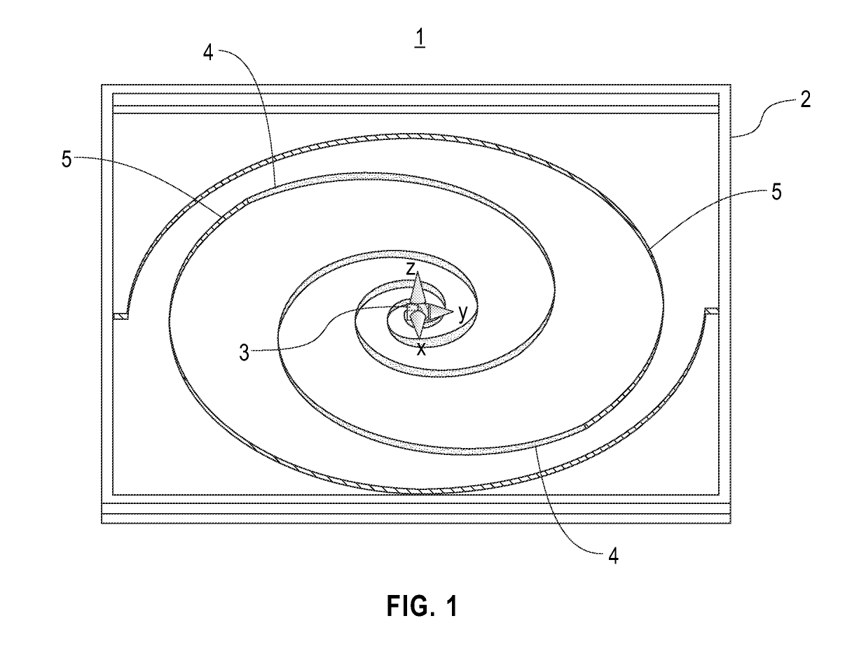

Referring now to FIG. 1, this top view shows a bolometer device for use in a bolometer array for imaging purposes. Bolometer device 1 can represent one pixel of the bolometer array.

Bolometer device 1 is defined by support frame 2. A plurality of support frames 2 can be attached in an array on a substrate (not shown). Support frames 2 span over a large cavity which has a size of the whole pixel array. In the interior of each support frame 2, temperature sensing element 3 is centrally arranged from which two antenna elements 4 extend outwardly. Antenna elements 4 can be substantially identical in size and shape. In the present embodiment, antenna elements 4 are formed of spiral arms and extend from the centrally-located temperature sensing element 3 to opposing outward directions. Antenna elements 4 are formed on or by the full or partial extension of the spiral arms.

For receiving electromagnetic radiation in a frequency range between 0.5 and 1.5 THz corresponding to wavelengths λ in a range between 200 μm and 600 μm, the side length of support frame 2 should be approximately 250 μm.

Each of the two antenna elements 4 is supported by holding element 5 with a holding arm bridging the respective antenna element 4 and one side of support frame 2. This ensures that the joint structure of antenna elements 4 and temperature sensing element 3 are supported in the interior formed by support frame 2 without coming into contact with the substrate or any surrounding structures.

Holding elements 5 are connected to an outer portion of antenna elements 4, so that holding elements 5 and antenna elements 4 do not intersect. This serves to avoid any thermal shortcut caused by tilting or deformation of antenna elements 4 and/or holding elements 5.

Holding elements 5 and antenna elements 4 are electrically conductive so as to carry a detection current to and from temperature sensing element 3 to perform a readout thereof. At the support frame 2, the holding elements 5 are therefore coupled with a readout circuit (not shown).

Bolometer device 1 can be substantially produced using a standard silicon technology, such as a CMOS process technology, forming the circuitry on temperature sensing element 3 and the metallization of antenna elements 4. Thereafter, antenna elements 4, temperature sensing device 3 and holding elements 5 are excavated from a polysilicon layer using an MEMS etching process. Antenna element 4 and holding element 5 can be substantially formed of a conductive material. Polysilicon is the preferred material for holding elements 5 as there are standard selective etching processes available.

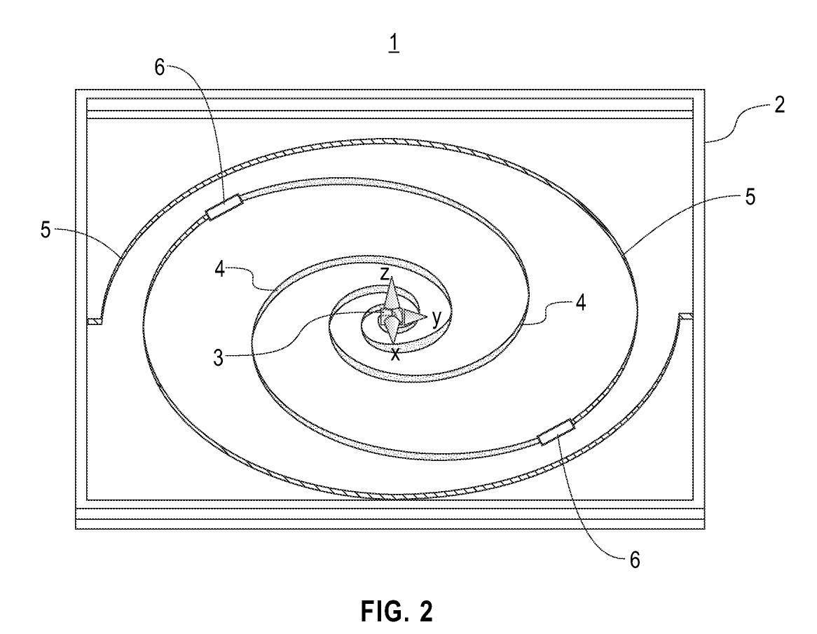

In order to tune the sensitivity of bolometer device 1 to a predetermined frequency range, the effective length of antenna elements 4 can be properly defined. Antenna elements 4 can extend from the centrally-located temperature sensing element 3 outwardly and can be substantially made of conductive material. To define the effective length of the part of the spiral arms which shall form antenna elements 4, termination element 6, as is shown in FIG. 2, can be formed on or in the spiral arms. Termination element 6 may be placed at a position such that the length between termination element 6 and the inner end of antenna element 4 at temperature sensing element 3 corresponds to the required length of antenna element 4 which is needed to obtain a required bandwidth and frequency range. In the context of this description, the length of the spiral arms, which extend outwardly from termination element 6, belongs to holding element 5. In other words, the portions of the spiral arms which extend outwardly from the respective termination element 6 correspond to a portion of the respective holding element 5.

Termination element 6 can be made of a short stretch of non-silicided silicon which has a high impedance and can be used to practically insulate antenna element 4 from the other portions of the spiral arm or the other portions of holding element 5, respectively. Termination element 6 can be configured to provide a full reflectivity for received electromagnetic radiation in the frequency range to be sensed. Termination element 6 can be provided as a resistivity or as an inductance which is dimensioned to define an electrical outer end of antenna element 4 for the electromagnetic radiation in the THz range.

Alternatively, instead of two spiral antenna elements 4, four spiral antenna elements 4 can be used, each of which is arranged around temperature sensing element 3 at an angle of 90° with respect to its neighboring antenna elements. Two holding elements 5 can be attached to one spiral antenna element 4. Using four antenna elements 4 can help to avoid asymmetry and therefore, a polarization asymmetry of the provided antennae.

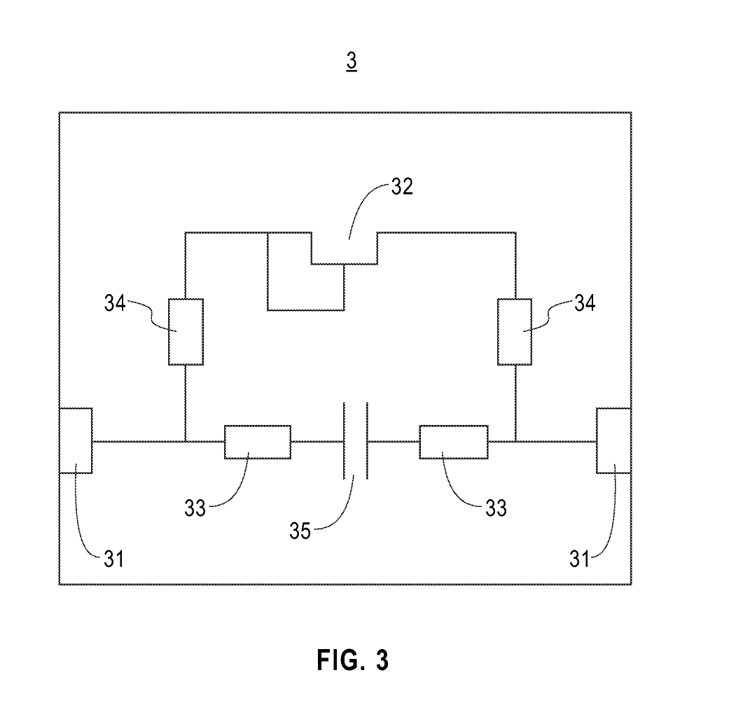

FIG. 3 shows a schematic of temperature sensing element 3. Not shown in FIG. 3 is temperature sensing element 3 electrically connected to a readout circuit outside of the bolometer device 1 via the conductive holding element 5 and the conductive antenna element 4. Hence, as antenna elements 4 are used both for receiving the electromagnetic radiation and for conducting the electrical signal for reading out temperature sensing element 3, temperature sensing element 3 only requires two contact terminals 31.

Temperature sensing element 3 includes active sensor element 32. A detection current through active sensor element 32 corresponds or may be associated to the temperature in temperature sensing element 3. Antenna elements 4, which are coupled with contact terminals 31, are terminated by termination resistors 33 which are serially connected between contact terminals 31 together with a serially connected blocking capacitor 35. Termination resistors 33 serve as terminations for the antenna. Blocking capacitor 35 serves to prevent DC current flowing through termination resistors 33. To block the AC current induced into the antenna by incoming electromagnetic radiation from flowing through sensor element 32, sensor element 32 is coupled in series with two blocking resistors 34 between contact terminals 31. As an example, termination resistors 33 can each have a resistance of 100Ω, while blocking resistors 34 can each have a resistance of 500 Ω.

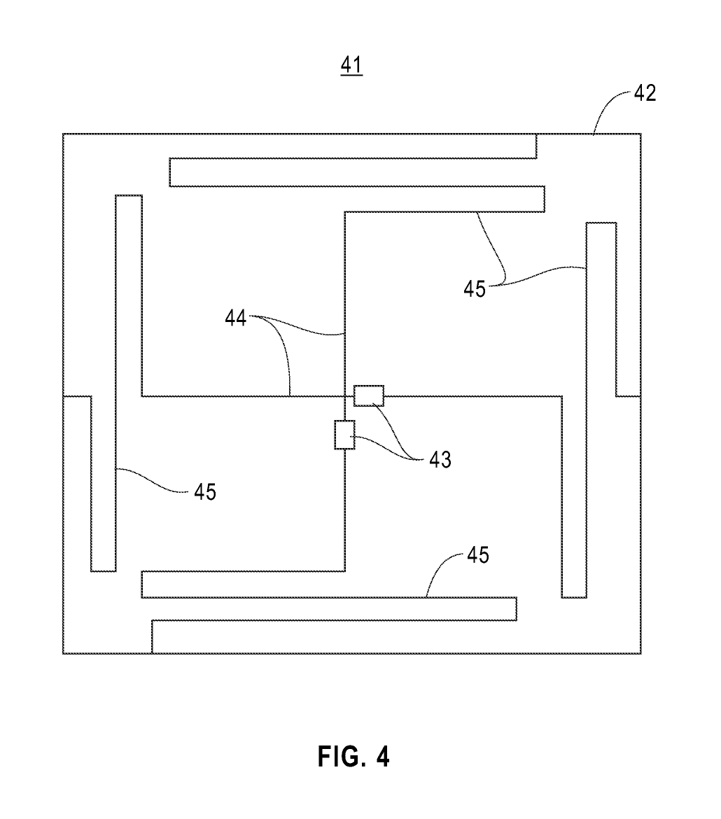

FIG. 4 shows a top view of another embodiment of a bolometer device. Bolometer device 41 has support frame 42 and two independent temperature sensing elements 43, each of which is coupled to a linear polarization antenna, such as a dipole antenna. The linear polarization antennae have two antenna elements 44 extending in opposite directions from the respective temperature sensing elements 43. Antenna elements 44 of the linear polarization antennae associated to the two independent temperature sensing elements 43 extend substantially perpendicularly to each other.

The ends of the dipole antennae are attached to holding elements 45, so that each end of antenna element 44 of the dipole antennae is connected to a respective side of the rectangular support frame 42 it is directed to. Each of the linear dipole antennae is configured to receive one polarization only and, due to the perpendicular arrangement, each linear dipole antenna can receive a vertical and horizontal linear polarization.

Holding elements 45 can be formed in a meandering fashion in order to increase the overall lengths of the respective antenna element 44 and holding element 45 between temperature sensing element 43 and the respective side of support frame 42. This provides the required thermal resistance between temperature sensing element 43 and the surrounding structures.

While temperature sensing element 43 can be implemented from active components in a SOI CMOS technology, holding elements 45 are formed of polysilicon and antenna elements 44 are formed of metal to improve the electrical conductivity of the antenna elements 44. To avoid electrical shorts between the perpendicularly crossing antenna elements 44, the antenna conductor, and at least at the crossing region of both dipole antennae, can be made of different metal layers. The physical separation between the two antenna elements 44 is achieved by slightly under-etching the structure since this also removes an insulating oxide between the metal layers. The two perpendicular antenna elements are further separated by purposely introducing stress. Due to different stress, one antenna will lift up out of the plane leading to additional separation.

Additionally or alternatively, holding elements 45 for holding antenna elements 44 of the one dipole antenna can have a length that differs from that of holding elements 45 for holding antenna elements 44 of the other dipole antenna. When forming holding elements 45, a material combination of polysilicon and silicon dioxide can be used, which can provide a structural stress in an upward direction away from the substrate so that the dipole antenna supported by the longer holding elements 45 is bent further upward after release by the MEMS process. As a result, antenna elements 44 of the dipole antennae cannot accidentally contact each other.

As already described above in conjunction with the spiral antenna elements, termination elements, such as a short stretch of non-silicided polysilicon with a higher resistivity, can be provided between antenna elements 44 of the dipole antennae and the respective holding elements 45 to act as a radio-frequency choke and to terminate the dipole antenna.

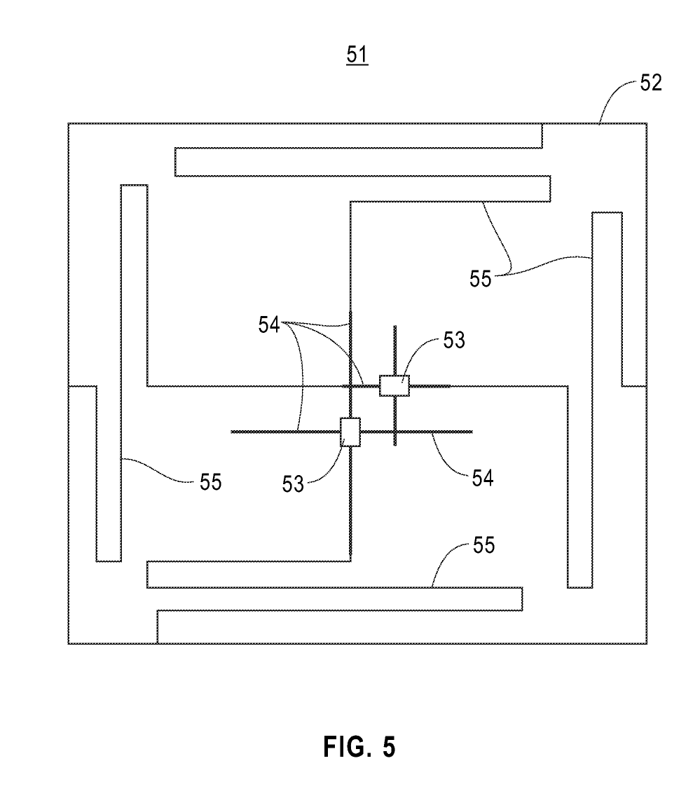

FIG. 5 shows a schematic of bolometer device 51, which is configured to receive two wavelengths separately, independently of its polarization. Bolometer device 51 has support frame 52, two temperature sensing elements 53, antenna elements 54 and four holding elements 55 arranged in a similar manner to FIG. 4 but differs from the embodiment in FIG. 4 in that a cross dipole antennae is provided for each temperature sensing element 53. Each cross dipole antenna has four antenna elements 54, each having the same length. Two opposite ends of antenna elements 54 of each of the cross dipole antennae can be supported by holding elements 55 as described above with respect to the embodiment in FIG. 4. Thus, holding elements 55 are arranged at four sides of support frame 52.

Antenna elements 54 of both cross dipole antennae can have different lengths, so that each of the cross dipole antennae is adapted to receive radiation in a different frequency range. Moreover, as each of temperature sensing elements 53 has a cross dipole antenna, radiation of two linear polarizations can be received for each frequency range. Antenna elements 54 of the two cross dipole antennae can overlap to keep a low distance between temperature sensing elements 53 within support frame 52, so that different wavelengths can be detected in one pixel without an offset.

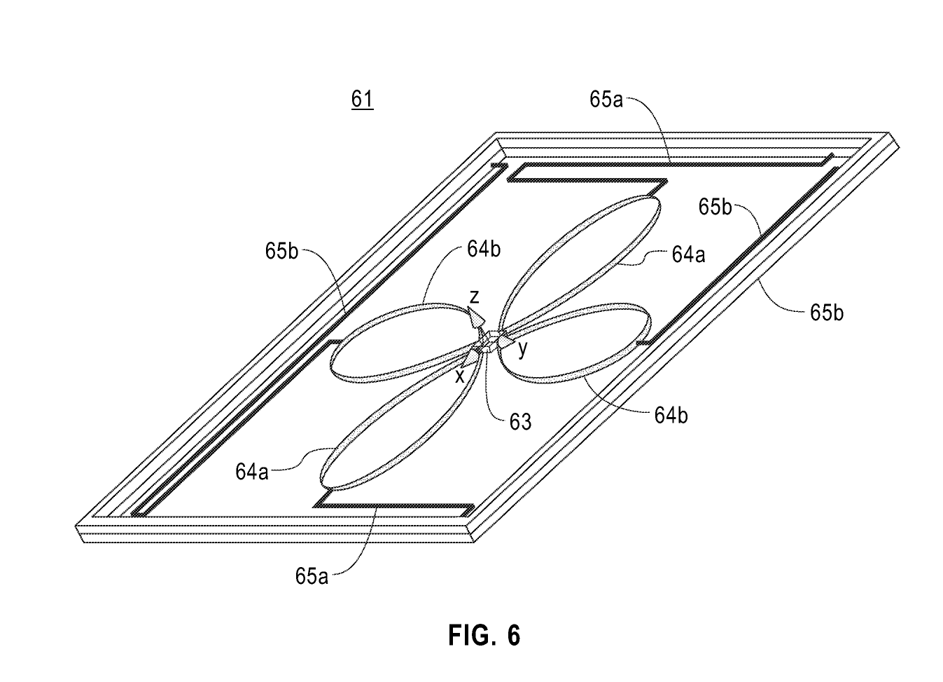

FIG. 6 shows a schematic of another configuration of a bolometer device. Bolometer device 61 has support frame 62, one temperature sensing element 63, antenna elements 64 and four holding elements 65. The antenna in this embodiment is formed as a cloverleaf antenna which is capable of receiving radiation with a horizontal and vertical linear polarization. The advantage of using the cloverleaf antenna is that an adequate matching of a wide frequency range can be obtained and that the antenna has a gain high enough to obtain an area efficiency of about the pixel size.

In this embodiment, the antenna can be made of a metal layer having four antenna elements 64 each forming one “leaf,” or winding, of the cloverleaf antenna. Each antenna element 64 is coupled to temperature sensing element 63 that is arranged in the center of support frame 62. Antenna elements 64 are substantially arranged perpendicularly to each other, while two opposite first antenna elements 64a are mechanically supported by first holding elements 65a. First holding elements 65a can connect first antenna elements 64a at a position most distanced from temperature sensing element 63. First holding elements 65a can be made of an electrically non-conductive material, such as silicon dioxide, which also provides a low thermal conductivity and strong mechanical support.

Two other antenna elements, second antenna elements 64b, arranged perpendicularly to first antenna elements 64a, are coupled with second holding element 65b, which is made of a conductive material, such as polysilicon or active silicon in an SOI process, to provide a path for the detection current for reading out temperature sensing element 63.

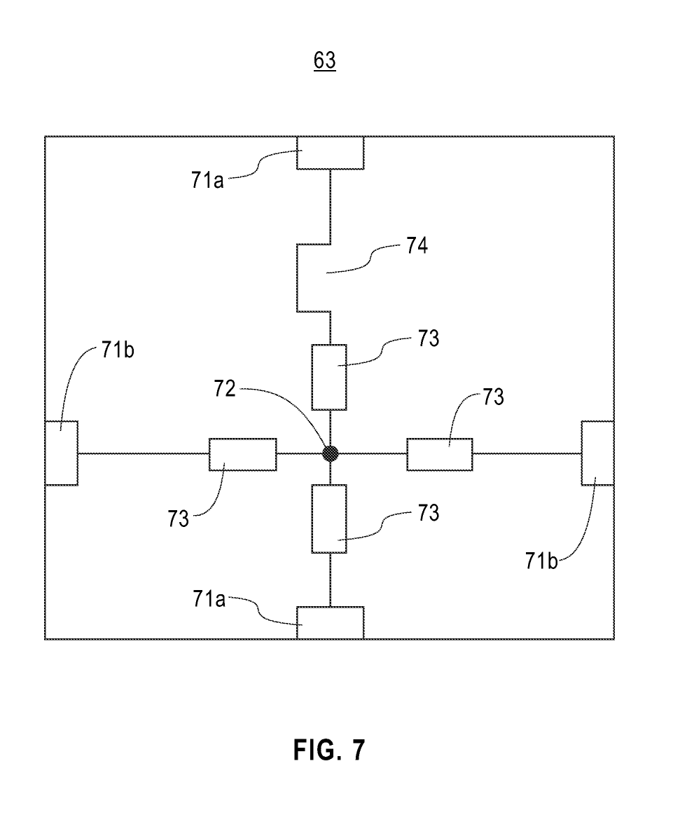

FIG. 7 shows a schematic of a circuit of the temperature sensing element 63 used for the cloverleaf antenna. Each of first and second antenna elements 64a, 64b (shown in FIG. 6) connects to a separate first or second contact terminal 71a, 71b, respectively. Contact terminals 71a, 71b are coupled to a common center node 72 via a respective termination resistor 73, which in the present embodiment, can have a resistor value of 100Ω. Field effect transistor device 74 is arranged in the detection current path between one of second contact terminals 71b and center node 72, is connected in series to termination resistor 73 in the same path, and acts as a diode. As the gate-source capacity of field effect transistor 74 provides a short circuit for the electromagnetic signal, the signal received by the second antenna elements is not attenuated by field effect transistor 74.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A bolometer device for use in a bolometer array, comprising:
a bolometer sensor comprising:
at least two antenna elements coupled with one of their ends at a center position;
a temperature sensing element attached at the center position for detecting a temperature at the center position and for providing an electrical measure in response to the detected temperature; and
at least one holding element to mechanically support the bolometer sensor at an end portion of a respective antenna element, wherein at least one of the holding elements is electrically conductive so that the electrical measure can be read out via the holding element.

2. The bolometer device according to claim 1, wherein the bolometer sensor is supported by at least one holding element, so that the bolometer sensor is kept distanced from surrounding structures.

3. The bolometer device according to claim 1, wherein the holding element has a length which provides a thermal resistivity of at least 5×10⁷ K/W.

4. The bolometer device according to claim 1, wherein the antenna elements are formed as to spirally extend in an outward direction from the center position.

5. The bolometer device according to claim 1, wherein the antenna elements are formed as to linearly extend in an outward direction from the center position.

6. The bolometer device according to claim 1, wherein the antenna elements form a cloverleaf antenna, wherein the antenna elements are formed as antenna windings which extend outwardly from the center position.

7. The bolometer device according to claim 1, wherein the antenna elements and the holding elements are integrally formed of an electrically conductive first material, wherein the antenna elements further include a layer of a second material with a better conductivity than the electrically conductive first material.

8. The bolometer device according to claim 1, wherein the holding elements are formed of an electrically conductive first material, wherein the antenna elements are made of a second material with a better conductivity than the electrically conductive first material.

9. The bolometer device according to claim 7, wherein the electrically conductive first material is polysilicon or active silicon.

10. The bolometer device according to claim 8, wherein the second material is metal.

11. The bolometer device according to claim 7, wherein termination elements with a higher impedance than the antenna elements and the holding elements are arranged between the holding elements and their respective antenna elements at positions to define effective lengths of the antenna elements.

12. The bolometer device according to claim 1, wherein the temperature sensing element has a circuit comprising:
a termination resistor for each of the antenna elements via which the antenna elements are coupled to a common node;
a capacitor for blocking a DC voltage or current caused by reading out the electrical measure; and
a temperature sensor coupled to the common node.

13. The bolometer device according to claim 10, wherein the temperature sensing element has blocking resistors for coupling the temperature sensor to respective antenna elements so that the current induced by the reception of electromagnetic radiation is substantially blocked from the temperature sensor.

14. The bolometer device according to claim 1, wherein the bolometer sensor is provided with four antenna elements extending crosswise from the center position.

15. The bolometer device according to claim 1, wherein a plurality of bolometer sensors are provided, wherein at least one antenna element of each of the bolometer sensors overlaps another antenna element of another one of the bolometer sensors, so that absorbing areas of the bolometer sensors overlap.

16. The bolometer device according to claim 13, wherein at least one of the holding elements for each of the plurality of the bolometer sensors are prestressed so that they are bent in a different direction, perpendicular to its extension plane, to increase the distance between crossing areas of the antennas elements.

17. The bolometer device according to claim 13, wherein the antenna elements of the bolometer sensors have different effective lengths to provide sensitivities in different frequency ranges.

18. The bolometer device according to claim 1, wherein at least one of the holding elements is for mechanically supporting the bolometer sensor only.

19. The bolometer device according to claim 1, wherein a support frame is provided in which the bolometer sensor is centrally arranged, wherein each of the holding elements couples the bolometer sensor with one side of the support frame.

20. A bolometer system comprising:
at least one bolometer devices of claim 17; and
a readout unit outside at least one of the support frames of at least one of the bolometer devices which is electrically coupled to at least one of the temperature sensing devices by at least one of the holding elements of each bolometer device.
